(19) United States
(12) Patent Application Publication
(10) Pub. No.: US 2014/0265298 A1
(43) Pub. Date: Sep. 18, 2014

(54) CLIPBOARD SYSTEM

(71) Applicant: David T. Cooper, Clinton Township, MI (US)

(72) Inventor: David T. Cooper, Clinton Township, MI (US)

(21) Appl. No.: 14/211,231

(22) Filed: Mar. 14, 2014

Related U.S. Application Data
(60) Provisional application No. 61/789,447, filed on Mar. 15, 2013.

(51) Int. Cl. B42F 9/00

(52) U.S. Cl. CPC B42F 9/001
USPC 281/45

(57) ABSTRACT

A double-sided clipboard system where each side of the double-sided clipboard system functions at least as a clipboard. The double-sided clipboard system may include a secondary retention system such as an elastic band for retaining clipboard items. The clipboard system may comprise a shoulder strap for carrying the system in different orientations. An attachable accessory bag is provided for containing and carrying the shoulder strap, writing instruments, and/or other supplies. The accessory bag may include an adjustable cinch which functions as an adjustable bag closure apparatus. A capture mechanism for a writing instrument or other compatible item is provided that enables the user to conveniently insert into and remove from the capture mechanism a writing instrument. The capture mechanism can be a surface-mounted mechanism or mounted via a through-hole of the main board.

### CROSS-REFERENCE TO RELATED APPLICATIONS

This application claims the benefit of pending U.S. Provisional Patent application Ser. No. 61/789,447 entitled “CLIPBOARD SYSTEM” and filed Mar. 15, 2013, the entirety of which is incorporated by reference herein.

### BACKGROUND

Clipboards find applicability in many different environments such as portable and stable writing surfaces for documents. Typical clipboards are handheld objects that require that at least one hand be occupied to hold the clipboard. This can be a limitation especially when working in environments where both hands may be required for other purposes, or in the least, placement of the clipboard while using both hands for other purposes may be problematic. Moreover, conventional clipboards are limited by requiring the user to stack dissimilar documents on one side of the clipboard, thereby requiring the user to remove and shuffle documents to reach the desired document for each purpose.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed system is a double-sided clipboard system where each side of the double-sided clipboard system functions at least as a clipboard. A main board, which may be generally rectangular in shape, defines a first major face and a second major face. The main board can include a top edge, a bottom edge, a first side edge, and a second side edge. The main board can also comprise a pair of clipping means—one clipping means for each face. The clipping means may be a spring-loaded clamp that retains items such as papers, pads of paper, and/or other suitable items against a major face of the clipboard system. The clipping means can be disposed near the top edge and may be mounted to sandwich the main board therebetween in a fastened relation.

The double-sided clipboard system may include a secondary retention system for retaining clipboard items. The secondary retention system can be an elastic band that cooperates with C-shaped notches disposed on opposing edges of the main board. Thus, the elastic band may be retained as inserted into the notches and around the main board. The secondary retention system may be disposed on the main board across the width defined by distance between the first side edge and the second side edge, and at any suitable location on the main board. For example, an elastic band may be disposed in cooperation with corresponding notches along any part of the width of the main board, such as in a lower half of the main board, nearer to the bottom edge, in the upper half of the main board, and so on. Thus, a clipboard item such as a legal pad maybe primarily retained by the clipping means near the top edge of the main board, and optionally, may be secondarily retained and secured using the secondary retention system near the lower edge of the main board.

The clipboard system may comprise a C-notch having an aperture which is located sufficiently close to an edge that the aperture breaks through a portion of the edge, thereby forming a C-shaped notch. Alternatively, a C-notch may comprise a through-hole near an edge of the main board, where an additional cut-out length is made from the side edge to the through-hole; thus forming a C-shaped notch, where the aperture if now formed as comprising the break in the edge and extending the length of the cut-out to the through-hole.

The clipboard system may further include a plurality of shoulder strap apertures in the main board, which are adapted to engage a shoulder strap. For example, one of the shoulder strap apertures may be located near a side edge of the clipboard system so that a clasp located at an end of the shoulder strap may engage the main board through one of the shoulder strap apertures.

The shoulder strap apertures are located near a side edge of the main board and sufficiently close to the side edge to enable a compatible clasp having a suitable and convenient size to be employed.

Alternatively, a single shoulder strap aperture in the main board can be suitably located and adapted to enable engagement of both clasps of the shoulder strap. The clipboard system may have two or more shoulder strap apertures so that each end of a shoulder strap may engage a different should-strap aperture.

The clipboard system may also include an attachable accessory bag suitably designed for containing and carrying the shoulder strap, writing instruments, and/or other supplies which may be needed by the user in the course of using the clipboard system. The accessory bag may include an adjustable cinch which functions as an adjustable bag closure apparatus.

The clipboard system may further comprise a capture mechanism for a writing instrument or other compatible item that enables the user to conveniently insert into and remove from the capture mechanism a writing instrument, for example. The capture mechanism can be a surface-mounted mechanism or mounted via a through-hole of the main board.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

The invention may take physical form in certain parts and arrangement of parts, embodiments of which will be described in detail in this specification and illustrated in the accompanying drawings which form a part hereof.

FIG. 1 illustrates a view of an exemplary double-sided clipboard system.

FIG. 2 illustrates a view of the clipboard system from the second major face.

FIG. 3 illustrates a close-up view of a notch that can be employed on the main board.

FIG. 4 illustrates a view of an alternative embodiment of the clipboard system.

FIG. 5 illustrates a close-up view of one of the shoulder strap apertures and a retention aperture.

### DETAILED DESCRIPTION

Embodiments may include a double-sided clipboard system, wherein each side of the system includes a clipboard. For instance, embodiments may include a main board, which may be generally rectangular in shape and may define a first major face and a second major face. The main board may also include a top edge, a bottom edge, a first side edge and a second side edge. Main boards may be made from a variety of convenient materials known in the art including wood, polycarbonate, polyolefin, or other common polymer materials.

Embodiments also include a pair of clipping means. A clipping means may be a spring-loaded clamp for retaining items such as papers or pads of paper against a major face of the clipboard system. Items retainable in this manner may be referred to herein as clipboard items, and are not intended to comprise a part of the invention. An embodiment may have the clipping means disposed near the top edge of either or both major faces. Furthermore, the clipping means may cooperate to sandwich the main board between them in a fastened relation.

Some embodiments may include a secondary retention system for retaining clipboard items. For example, a secondary retention system can comprise an elastic band which cooperates with notches (e.g., C-shaped notches) disposed on opposing edges of a main board. Thus, the elastic band may be retained by the notches. Furthermore, the secondary retention system may be disposed in the lower half of the main board, or even nearer to the bottom edge. Thus, a clipboard item such as a legal pad maybe primarily retained by the clipping means near the top edge of the main board, but may be secondarily retained and secured using the secondary retention system near the lower edge of the main board. Such an arrangement may be especially suitable for outdoor applications that may be exposed to wind, or any time a user wishes hold a lower edge of an item.

According to embodiments of the invention, a C-notch (used interchangeably with C-shaped notch) may comprise an aperture, which is located so close to an edge that it breaks through a portion of the edge, thereby forming the C-shaped notch. Alternatively, a C-notch may comprise a through-hole near an edge of a main board, where an additional cut-out is made from the side edge to the through-hole thus forming a C-shaped notch.

Embodiments may further include a plurality of shoulder strap apertures, which are adapted to engage a shoulder strap. For example, a shoulder strap aperture may be located near a side edge of the system so that a clasp located at an end of a shoulder strap may engage main board through the shoulder strap aperture. To further illustrate, if a shoulder strap aperture is located too far from a side edge of the system then a clasp would need to be excessively and/or inconveniently large in order to engage it. Thus, as used herein, shoulder strap apertures, which are said to be located near a side edge of the system are close enough to the side to allow a clasp having a convenient size to be used. Embodiments may have a single shoulder strap aperture adapted to engage both clasps of a shoulder strap, i.e., the clasps at either end thereof. Alternatively, embodiments may have two or more shoulder strap apertures so that each end of a shoulder strap may engage a different shoulder strap aperture.

According to one embodiment, a system includes a pair of shoulder strap apertures near the first side edge of the main board, and a second pair of shoulder strap apertures near the second edge thereof. Furthermore, the pairs of shoulder strap apertures on the respective sides may be spaced apart so that one is near the top edge of the main board and the other is near the bottom edge of the main board. Placement of the shoulder strap apertures in this way may enable a user to select one of four preferred orientations for carrying the system. Particularly, if either end of a shoulder strap is affixed to the shoulder strap apertures near the top edge, then the system will be carried in an upright orientation. Conversely, if the shoulder strap apertures near the bottom edge are engaged then the system will be carried in an inverted orientation. Alternatively, one end of a shoulder strap may engage an aperture near the top edge of a side and the other may engage the aperture near the bottom edge of the same side. Thus, the system would be carried in a sideways orientation.

A shoulder strap according to embodiments of the invention may comprise a generally elongate strip of fabric having clasps at either end. Furthermore, suitable shoulder straps may be adjustable in length to allow for users of different sizes or body types. The shoulder strap may have a clasp at either end, and the clasp may comprise a circular hook, which may be closable or partially closable so as to resist disengaging a shoulder strap aperture. Furthermore, a clasp may further include a through-hole which may be adapted to engage an elastic band. For instance, both ends of an elastic band may engage the through-holes clasps located at either end of a shoulder strap. According to some embodiments, joining the clasps of a shoulder strap in this way may assist a user of the embodiment in keeping the strap around his neck or shoulder even if the clipboard is disengaged from the shoulder strap clasps.

Embodiments may also include an accessory bag suitable for containing and carrying the shoulder strap, pens, or other supplies which may be needed in the course of using the clipboard system. Accessory bags according to embodiments of the invention may include a cinch which may function as a bag closure. Furthermore, the accessory bag may also include a fastening means such as a clasp which may be adapted to engage an accessory aperture disposed near a bottom edge of the main board.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. The drawings are for purposes of illustrating embodiments of the invention only and not for purposes of limiting the same.

FIG. 1 illustrates a view 100 of a double-sided clipboard system 101 in accordance with the invention. Each side of the double-sided clipboard system 101 includes a clipboard. For instance, embodiments may include a main board 102, which may be generally rectangular in shape (although other shapes may be employed) and may define a first major face 104 and a second major face 106. The label of the first major face 104 is shown in a box having a solid border to indicate the first major face 104 is the closest to the viewer. In contrast, the label of the second major face 106 is shown in a box having a dashed border to indicate the second major face 106 is the underside of the main board 102 or farthest from the viewer.

The main board 102 may also include a top edge 108, a bottom edge 110, a first side edge 112 and a second side edge 114. Main boards may be made from a variety of convenient materials known in the art including wood, metal, polycarbonate, polyolefin, and/or other common polymer materials, for example. Additionally, the transparency of the main board 102 may range from entirely translucent to opaque.

The main board 102 can also include a pair of clipping means 116—one clipping means for each side (e.g., on the first major face 104 and on the second major face 106) of the main board 102. The clipping means 116 may be a spring-loaded clamp that retains items such as papers, pads of paper, and/or other suitable items against a major face (e.g., the first major face 104) of the clipboard system 101. Items retainable in this manner may be referred to herein as clipboard items, and are not intended to comprise a part of the invention. An embodiment may have the clipping means 116 disposed near the top edge 108 of either or both major faces (104, 106). Furthermore, the clipping means 116 may be mounted to sandwich the main board 102 therebetween in a fastened relation.

Some embodiments may include a secondary retention system for retaining clipboard items. For example, the main board 102 can comprise an elastic band 118 as the secondary retention system, which cooperates with C-shaped notches 120 (each having an open portion into which manual insertion of the elastic band 118 can be performed) disposed on opposing edges (e.g., the first side edge 112 and the second side edge 114) of the main board 102. Thus, the elastic band 118 may be retained as inserted into the notches 120 and around the main board 102.

Furthermore, the secondary retention system may be disposed on the main board 102 across the width defined by distance between the first side edge 112 and the second side edge 114, and at any suitable location on the main board 102. For example, the elastic band 118 may be disposed in cooperation with corresponding notches along any part of the width of the main board 102, such as in a lower half of the main board 102, nearer to the bottom edge 110, in the upper half of the main board 102, and so on. Thus, a clipboard item such as a legal pad maybe primarily retained by the clipping means 116 near the top edge 108 of the main board 102, and optionally, may be secondarily retained and secured using the secondary retention system (e.g., the elastic band 118) near the lower edge 110 of the main board 102. Such an arrangement may be especially suitable for outdoor applications where the clipboard items may be exposed to wind, and/or any time a user wishes hold a lower edge of an item.

According to embodiments of the clipboard system 101, a C-notch (of the C-notches 120) may comprise an aperture (open portion) which is located sufficiently close to an edge (e.g., the first side edge 112) that the aperture breaks through a portion of the edge, thereby forming a C-shaped notch. Alternatively, a C-notch may comprise a through-hole near an edge (e.g., the first side edge 112) of the main board 102, where an additional cut-out length is made from the side edge (e.g., first side edge 112) to the through-hole; thus forming a C-shaped notch, where the aperture if now formed as comprising the break in the edge and extending the length of the cut-out to the through-hole.

Embodiments such as the clipboard system 101 may further include a plurality of shoulder strap apertures 122 in the main board 102, which are adapted to engage a shoulder strap 124. For example one of the shoulder strap apertures 122 may be located near a side edge (e.g., the first side edge 112) of the clipboard system 101 so that a clasp (of clasps 126) located at an end of a shoulder strap 124 may engage the main board 102 through the one of the shoulder strap apertures 122.

To further illustrate, if a shoulder strap aperture is located too far (an excessive distance) from a side edge (e.g., the first side edge 112) of the main board 102, then a clasp would need to be excessively and/or inconveniently large in order to engage the should-strap aperture. Thus, as used herein, the shoulder strap apertures 122 are located near a side edge (e.g., the first side edge 112) of the main board 102 and sufficiently close to the side edge to enable a compatible clasp having a suitable and convenient size to be employed.

Alternatively, embodiments may have a single shoulder strap aperture in the main board 102 suitably located and adapted to enable engagement of both clasps (e.g., clasps 126, where each clasp is captured at an end or intermediate portion of the strap 124) of the shoulder strap 124. Alternatively, embodiments of the clipboard system 101 may have two or more shoulder strap apertures so that each end of a shoulder strap may engage a different should-strap aperture.

According to one embodiment, the clipboard system 101 includes a first pair 128 of shoulder strap apertures 122 near (aligned along) the first side edge 112 of the main board 102, and a second pair 130 of shoulder strap apertures near the second side edge 114 of the main aboard 102. Furthermore, the pairs (128 and 130) of shoulder strap apertures on the respective sides (112 and 114) may be spaced apart so that one pair of apertures is near the top edge 108 of the main board 102 and the other pair of apertures is near the bottom edge 110 of the main board 102. Placement of the shoulder strap apertures (128 and 130) in this way enables a user to select one of four orientations for carrying the clipboard system 101. For example, if either end of a shoulder strap 124 is affixed to the shoulder strap apertures (e.g., one of the pair 128 and one of the pair 130) near the top edge 108, then the system 101 can be carried in an upright orientation (the main board 102 is suspended by the strap 124 so the top edge 108 is up).

In another example, if the shoulder strap apertures (e.g., one of the pair 128 and one of the pair 130) near the bottom edge 110 of the main board 102 are engaged then the system 101 can be carried in an inverted orientation (the main board 102 is suspended by the strap 124 so the bottom edge 110 is up).

Still alternatively, one end (via a clasp) of a shoulder strap 124 may engage an aperture near the top edge 108 of a side (e.g., the first edge 112) and the other one end (via a clasp) may engage the aperture near the bottom edge 110 of the same side (e.g., the first edge 112); hence, the clipboard system 101 would be carried in a sideways orientation.

A shoulder strap (e.g., the shoulder strap 124) according to embodiments of the clipboard system 101 may comprise a generally elongate strip of flexible fabric having clasps (e.g., J-hook) at either end. Suitable shoulder straps may be adjustable in length to enable utilization by users of different sizes or body types. The shoulder strap 124 may have a clasp at either end, and the clasp may comprise a circular hook, which may be closable or partially closable so as to resist disengaging a shoulder strap aperture (of the shoulder strap apertures 122). Additionally, a clasp may further include a through-hole which may be adapted to engage an elastic band. For instance, both ends of an elastic band may engage the through-holes of the clasps located at either end of a shoulder strap 124. According to some embodiments, joining the clasps of a shoulder strap (e.g., should strap 124) in this way may assist a user of the embodiment in keeping the strap around the neck or shoulder even if the main board 102 is disengaged from the shoulder strap clasps.

Embodiments may also include an accessory bag 132 suitably designed for containing and carrying the shoulder strap 124, writing instruments (e.g., pens), and/or other supplies which may be needed by the user in the course of using the clipboard system 101. Accessory bags according to disclosed embodiments may include a cinch (e.g., adjustable) which functions as a bag closure apparatus. Additionally, the accessory bag 132 may include a fastening means, such as a clasp, which can be adapted to engage an accessory aperture 134 disposed near the bottom edge 110 of the main board 102.

As shown, the main board 102 may further comprise a capture mechanism 136 for a writing instrument (e.g., pen, pencil) or other compatible item that enables the user to conveniently insert into and remove from the capture mechanism 136 a writing instrument, for example. The capture mechanism 136 may be mounted on either face (e.g., the first major face, or the second major face 106) of the main board 102, along an edge (e.g., the first side edge 112 or the second side edge 114) so as to be out of the way of papers captured by the clipping means 116. The capture mechanism 136 can also be a two-part apparatus (similar to the clapping means 116) where a capture part is mounted on each face (104 and 106) such that flipping the mainboard during use enables access to a second object captured in the capture part of the captured mechanism 136.

The capture mechanism 136 can be a surface-mounted mechanism or mounted via a through-hole of the main board 102. It is to be appreciated that the capture mechanism 136 and main board 102 can be designed for mounting along any edge and either face (104 or 106), as desired by a given user.

Put another way, the double clipboard system is provided that comprises: a flat and generally rectangular main board having a first major face and a second major face, a top edge, a bottom edge, a first side edge, and a second side edge; a first clipping means permanently affixed near the top edge of the first major face, and a second clipping means permanently affixed near the top edge of the second major face; a secondary retention system comprising a pair of C-notches disposed at opposing side edges of a main board, the C-notches retaining an elastic band therein which surrounds a circumference of the main board; a plurality of shoulder strap apertures near one or more side edges of the main board; and a shoulder strap having a first end and a second end, wherein each end includes a fastening means adapted to engage one of the four shoulder strap apertures.

The double clipboard system can further comprise a pen-retaining means disposed near either the first or second side edge of either the first or second major face. The plurality of shoulder strap apertures comprises four shoulder strap apertures, wherein two shoulder strap apertures are disposed near the first side edge of the main board, and two shoulder strap apertures are disposed near the second side edge of the main board. The double clipboard system can further comprise at least one accessory aperture disposed near the lower edge of the main board. The double clipboard system can further comprise a cinchable accessory bag including a cinch string, the cinch string having a fastening means adapted to engage the at least one accessory aperture.

FIG. 2 illustrates a view 200 of the clipboard system 101 from the second major face 106. The clipping means 116 enables the secure clamping of clipboard items on either or both faces (104 or/and 106) of the main board 102. The accessory bag (132) suspends below the bottom edge 110 of the main board 102 to enable access from either face (104 or 106) being used.

FIG. 3 illustrates a close-up view 300 of a C-notch 302 that can be employed on the main board 102. The C-notch 302 comprises an aperture 304 that enables the secondary retention system (e.g., the elastic band 118) to engage and be retained by the main board 102.

FIG. 4 illustrates a view 400 of an alternative embodiment of the clipboard system 101. Here, a double clipboard 402 includes the same features as the clipboard 102 of FIG. 1, with the alternative features of shoulder strap apertures 404 being constructed into the four corner areas of the clipboard 402 as apertures that enable the clasps 126 to slide the extent of the given aperture.

FIG. 5 illustrates a close-up view 500 of one of the shoulder strap apertures 404. A secondary retention strap 502 is shown moved outside a retention aperture 504 to expose a C-notch type retention aperture into which the retention strap 502 is retained.

It will be apparent to those skilled in the art that the above methods and apparatuses may be changed or modified without departing from the general scope of the invention. The invention is intended to embrace all such modifications, variations, and alterations that fall within the scope of the appended claims or the equivalents thereof. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A double clipboard system, comprising:
a flat and generally rectangular main board having a first major face and a second major face, a top edge, a bottom edge, a first side edge, and a second side edge;
a first clipping means permanently affixed near the top edge of the first major face, and a second clipping means permanently affixed near the top edge of the second major face;
a secondary retention system comprising a pair of C-notches disposed at opposing side edges of a main board, the C-notches retaining an elastic band therein which surrounds a circumference of the main board;
a plurality of shoulder strap apertures near one or more side edges of the main board; and
a shoulder strap having a first end and a second end, wherein each end includes a fastening means adapted to engage one of the four shoulder strap apertures.

2. The double clipboard system of claim 1, further comprising a pen-retaining means disposed near either the first or second side edge of either the first or second major face.

3. The double clipboard system of claim 1, wherein the plurality of shoulder strap apertures comprises four shoulder strap apertures, wherein two shoulder strap apertures are disposed near the first side edge of the main board, and two shoulder strap apertures are disposed near the second side edge of the main board.

4. The double clipboard system of claim 1, further comprising at least one accessory aperture disposed near the lower edge of the main board.

5. The double clipboard system of claim 4, further comprising a cinchable accessory bag including a cinch string, the cinch string having a fastening means adapted to engage the at least one accessory aperture.
